(19) United States
(12) Patent Application Publication
(10) Pub. No.: US 2009/0021042 A1
(43) Pub. Date: Jan. 22, 2009

(54) FOLDING CANOPY FOR A MOTOR VEHICLE

(75) Inventors: Peter Biecker, Oberhaching (DE); Rudolf Dietl, Munich (DE)

Correspondence Address: DICKINSON WRIGHT PLLC, 1875 Eye Street, NW, Suite 1200, WASHINGTON, DC, 20006, US

(73) Assignee: Webasto Ag, Stockdorf (DD)

(21) Appl. No.: 12/280,274

(22) PCT Filed: Feb. 5, 2007
(86) PCT No.: PCT/DE2007/000227

§ 371 Date: Aug. 21, 2008

(30) Foreign Application Priority Data
Feb. 28, 2006 (DE) 102006009264.3

(51) Int. Cl. B60J 7/12

(52) U.S. Cl. 296/107.09

(57) ABSTRACT

The invention relates to a folding canopy for a motor vehicle, having a canopy linkage arrangement which has a main member (12) and a main column (14), wherein the main member and the main column are mounted via in each case one first hinge point (16, 18) on a main bearing, which is fixed to the body, of the vehicle, and are articulately connected to one another via in each case one second hinge point (20, 22) by means of a connecting element (24), and having a seal carrier (26) which is moveably connected to the main column. It is provided according to the invention that the main member (12) and the seal carrier (26) are articulately connected to one another by means of a transverse member (28).

The present invention relates to a folding canopy for a motor vehicle, with a canopy linkage which has a main link and a main pillar, wherein the main link and the main pillar are mounted via a respective first hinge point on a body-mounted main bearing of the vehicle, and are connected to each other in an articulated manner via a respective second hinge point by means of a connecting element, and a seal carrier which is connected movably to the main pillar. Furthermore, the invention relates to a motor vehicle with a folding canopy.

An important object in the construction of folding canopies is the space-saving accommodation of the put-away canopy. In particular, it is endeavored to pivot the seal carriers, which are attached to the canopy linkage, into a space-saving position when putting away the canopy. The present invention is concerned in this regard with the seal which is arranged on the C pillar of the folding canopy and, in the closed state of the canopy, provides a sealing function for the rear side window of the vehicle.

DE 100 51 436 A1 already describes a useful option for the space-saving accommodation of the rear seal. In this case, the seal carrier is connected to the main pillar in an articulated manner, and it is furthermore articulated via a coupling rod fastened in an articulated manner to the body-mounted main bearing. This has the result that, when the main pillar is pivoted to the rear via the coupling rod, a force is exerted on the seal carrier, the force bringing the latter into a space-saving position in the put-away state of the canopy. In this system, due to the lever ratios, high forces occur which may ultimately lead to severe stresses on the material. Since, furthermore, the main pillar takes up a defined position with respect to the vehicle body because of the coupling rod, additional measures have to be taken in order to optimally position the main pillar and in particular the seal during the assembly of the canopy.

The invention is based on the object of improving the prior art systems described, in particular with regard to the forces which occur when the canopy is put away and with regard to the variability of the assembly of the canopy.

This object is achieved by the features of the independent claim.

Advantageous embodiments of the invention are provided in the dependent claims.

The invention builds on the folding canopy of the type in question in that the main link and the seal carrier are connected to each other in an articulated manner via a transverse link. By this means, the stroke which is undertaken by means of the transverse link and which brings about the pivoting of the seal carrier is based on the relative movement of main link and main pillar. The angle at which the transverse link acts on the seal carrier is more obtuse than in the prior art systems, and therefore, with regard to the active forces, improved efficiency is provided for the pivoting movement of the seal carrier. The transverse link lies fully within the construction space for the canopy linkage such that, in particular with regard to the pivoting of the seal carrier, no arrangements whatsoever have to be made on the vehicle body shell.

According to a preferred embodiment, it is provided that the seal carrier is connected to the main pillar in a manner such that it can pivot about an axis of rotation. A particularly simple coupling of seal carrier and main pillar is involved here.

However, in the event of particular demands being imposed on the relative movement of seal carrier and main pillar, it can also be provided that the seal carrier is connected to the main pillar in an articulated manner by means of a hinge mechanism.

The invention is useful in particular in the context of the main pillar being arranged in front of the main link in the direction of travel. In this case, particularly advantageous lever ratios can be realized.

However, it can also be provided that the main pillar is arranged behind the main link in the direction of travel.

The invention is also advantageous in the context of the position of the seal carrier being adjustable via the arrangement of the transverse link. In addition to its force transmission function, the transverse link can therefore additionally be used to adjust the position of the seal carrier, which simplifies the assembly of the canopy.

In this context, it is useful for the arrangement of the transverse link to be adjustable by means of changing the position of the hinge point via which the transverse link is connected to the main link.

The invention is advantageously developed in that, in the open state of the folding roof, the seal carrier lies at least partially on that side of the main pillar which faces away from the put-away folding canopy. Construction space is therefore saved in the vertical direction by use being made of storage space available on the outer side of the main pillar.

The invention furthermore relates to a motor vehicle with a folding canopy according to the invention.

The invention is now explained by way of example using particularly preferred embodiments and with regard to the accompanying drawings, in which:

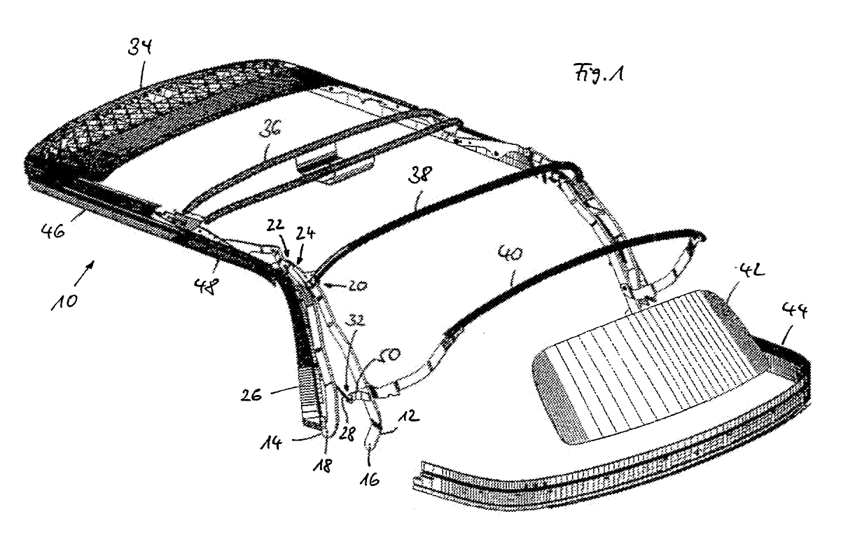

FIG. 1 shows a perspective illustration of a folding canopy according to the invention in the closed state;

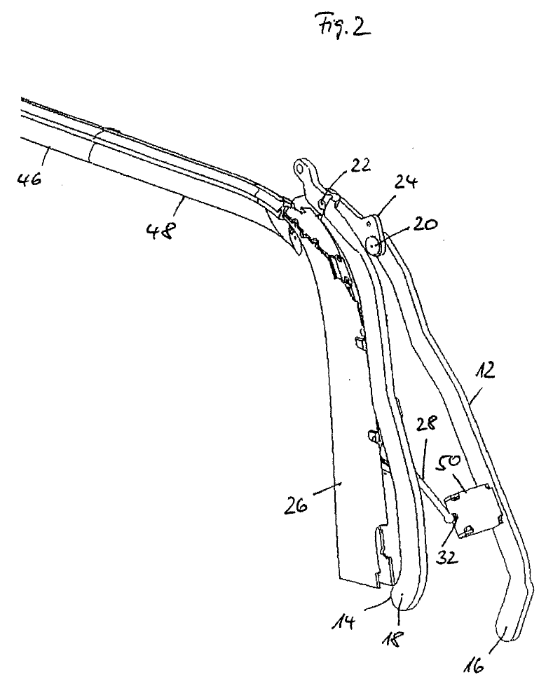

FIG. 2 shows a perspective illustration of a section of a folding canopy according to the invention in the region of the C pillar in the closed state of the folding canopy, from a lateral perspective;

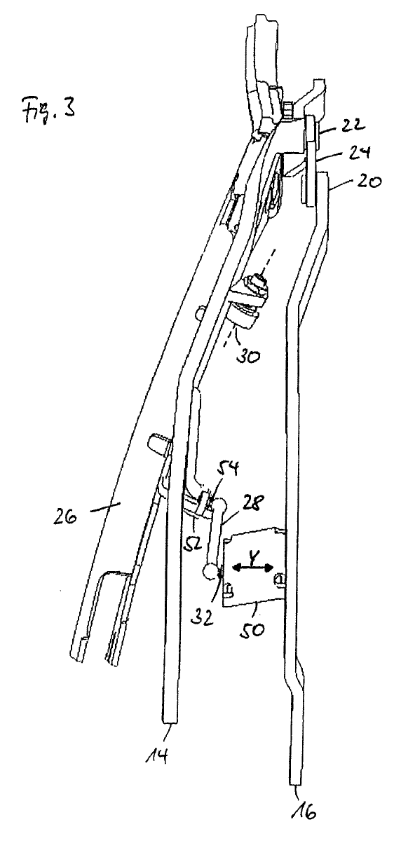

FIG. 3 shows the section according to FIG. 2 from behind, as viewed in the direction of travel;

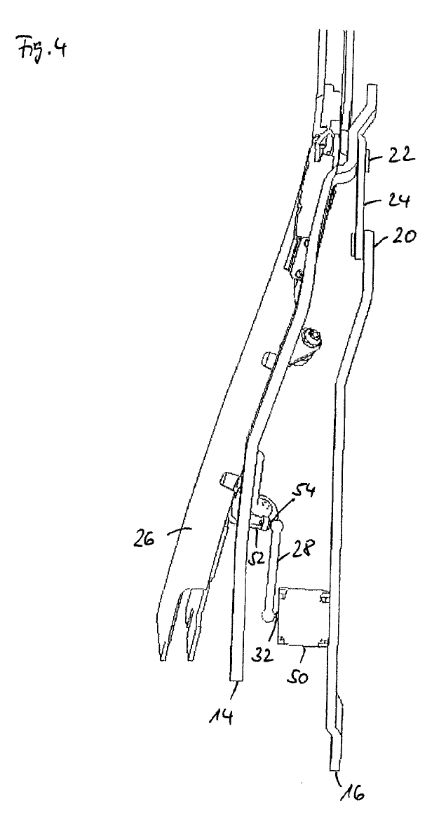

FIG. 4 shows the section according to FIG. 2 from a slightly raised perspective in comparison to FIG. 3;

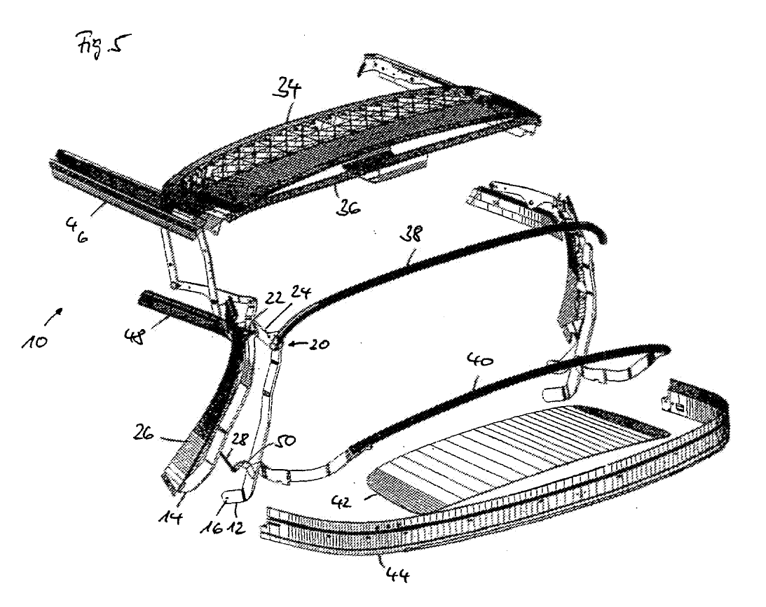

FIG. 5 shows a perspective illustration of the folding canopy according to FIG. 1 in an intermediate position between the closed and put-away state;

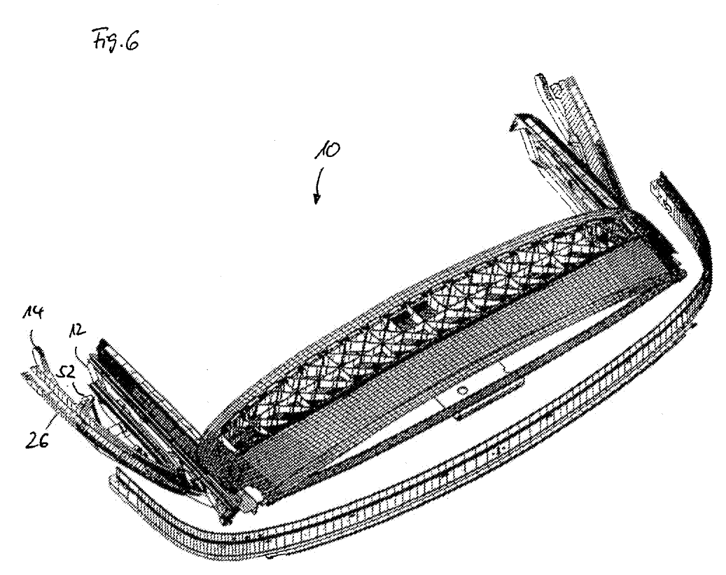

FIG. 6 shows a perspective illustration of the folding canopy according to FIG. 1 in the put-away state; and

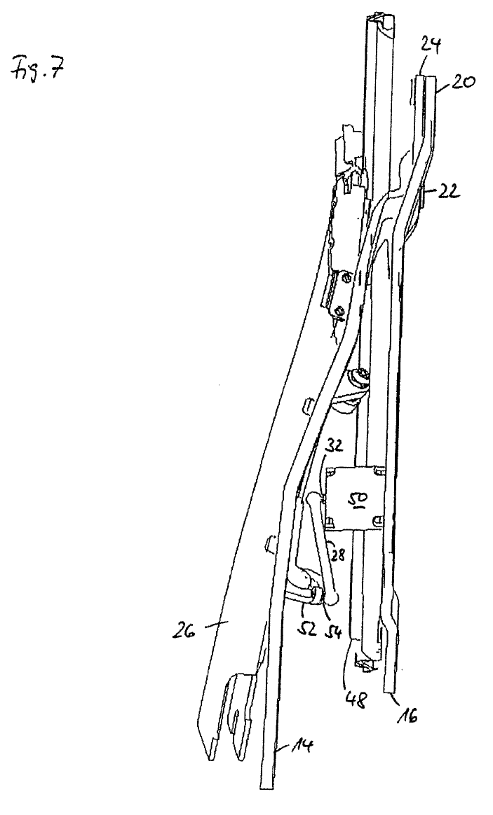

FIG. 7 shows the section according to FIG. 2 in the put-away state of the folding canopy, as viewed from below.

FIGS. 1 to 4 show a folding canopy 10 or a section of a folding canopy 10 in the region of the C pillar. FIG. 2 shows a section from a lateral viewing direction, FIG. 3 shows the section, as viewed from behind, and FIG. 4 shows the section from a slightly raised viewing position compared to FIG. 3. The folding canopy 10 comprises, from front to rear in the direction of travel, a front bow 34, a roof cassette 36, a main bow 38 and a corner bow 40. Furthermore, a rear window 42 and a tensioning bow 44 are arranged in the rear region of the folding canopy. The bows 34, 38, 40 and the roof cassette 36 form canopy linkage elements which run transversely with respect to the direction of travel and are connected laterally to side parts of the canopy linkage. The rear lateral elements of the canopy linkage are of particular interest in conjunction with the present invention. These are, in particular, a main link 12 and a main pillar 14 which are connected in an articulated manner to a body-mounted main bearing (not illustrated) via hinge points 16, 18. At their other end regions, the main link 12 and the main pillar 14 are connected to each other in an articulated manner by means of an intermediate element 24 via hinge points 20, 22 such that, overall, a four-bar linkage is formed. The further central and front lateral elements of the canopy linkage adjoin the main pillar 18. A front seal carrier 46 and a central seal carrier 48 are fastened to said front and central lateral elements of the canopy linkage. A rear seal carrier 26 is arranged on the main pillar 14 in an articulated manner via an axis 30. A transverse link 28 is provided between the rear seal carrier 26 and the main link 16, said transverse link being connected in an articulated manner both to the seal carrier 26 and to the main link 12. An intermediate piece 50 is arranged between the main link 12 and the transverse link 28, said intermediate piece being connected fixedly at one end to the main link 12 while it provides a hinge point 32 for the connection to the transverse link 28. The intermediate piece 50 can be realized in a different manner, as can also be seen by way of the different embodiments in FIGS. 1, and 2 to 4. For example, it may be a tab-like metal piece or else a box-shaped intermediate element. More usefully, the intermediate piece 50 and/or the arrangement of the hinge point 32 on the intermediate piece 50 is variable in the Y direction, that is to say horizontally transversely with respect to the direction of travel, such that the position of the seal carrier 26 can thereby be adjusted in the Y direction. An intermediate piece 52 which provides the second hinge point 54 for the transverse link is likewise provided on the seal carrier 26. It is also conceivable for the arrangement to be adjustable in the Y direction in the region of said intermediate piece.

FIG. 5 shows a perspective illustration of the folding canopy according to FIG. 1 in an intermediate position between a closed and put-away state. In order to put the folding canopy away, the main link 12 and the main pillar 14 are pivoted to the rear via a drive (not illustrated), with various parallelogram-like intermediate states being taken up successively on account of the arrangement in the manner of a four-bar linkage.

FIG. 6 shows a perspective illustration of the folding canopy according to FIG. 1 in a put-away state. FIG. 7 shows the section according to FIG. 2 in a put-away state of the folding canopy, as viewed from below. In the put-away state of the folding canopy 10, the seal carrier 26, and therefore in practice also the seal carried by the latter, lie at least partially outside the main pillar 14 and in particular not fully over the main pillar 14. The overall height of the put-away folding canopy 10 thereby remains small. The stroke which brings the seal carrier 26 into its put-away position is based on the relative movement between main link 16 and main pillar 18, with, owing to the favorable force transmission angles, comparatively small forces sufficing in order to bring about the advantageous put-away position of the seal carrier 26.

The features of the invention which are disclosed in the above description, in the drawings and in the claims may be essential both individually and also in any desired combination for implementing the invention.

### LIST OF REFERENCE NUMBERS

10 Folding canopy
12 Main link
14 Main pillar
16 Hinge point
18 Hinge point
20 Hinge point
22 Hinge point
24 Connecting element
26 Seal carrier
28 Transverse link
30 Axis of rotation
32 Hinge point
34 Front bow
36 Roof cassette
38 Main bow
40 Corner bow
42 Rear window
44 Tensioning bow
46 Front seal carrier
48 Central seal carrier
50 Intermediate piece
52 Intermediate piece
54 Hinge point

1. A folding canopy for a motor vehicle, with
a canopy linkage which has a main link and a main pillar, wherein the main link and the main pillar are mounted via a respective first hinge point on a body-mounted main bearing of the vehicle, and are connected to each other in an articulated manner via a respective second hinge point by means of a connecting element, and
a seal carrier which is connected movably to the main pillar,
characterized in that the main link and the seal carrier are connected to each other in an articulated manner via a transverse link.

2. The folding canopy of claim 1, characterized in that the seal carrier is connected to the main pillar in a manner such that it can pivot about an axis of rotation.

3. The folding canopy of claim 1, characterized in that the seal carrier is connected to the main pillar in an articulated manner by means of a hinge mechanism.

4. The folding canopy of claim 1, characterized in that the main pillar is arranged in front of the main link in the direction of travel.

5. The folding canopy of claim 1, characterized in that the main pillar is arranged behind the main link in the direction of travel.

6. The folding canopy of claim 1, characterized in that the position of the seal carrier can be adjusted via the arrangement of the transverse link.

7. The folding canopy of claim 6, characterized in that the arrangement of the transverse link can be adjusted by means of changing the position of the hinge point via which the transverse link is connected to the main link.

8. The folding canopy of claim 1, characterized in that, in the open state of the folding roof, the seal carrier lies at least partially on that side of the main pillar which faces away from the put-away folding canopy.

9. A motor vehicle with a folding canopy of claim 1.
